(19) United States
(12) Patent Application Publication
(10) Pub. No.: US 2015/0061402 A1
(43) Pub. Date: Mar. 5, 2015

(54) POWER RECEPTION DEVICE, POWER TRANSMISSION DEVICE AND POWER TRANSFER SYSTEM

(71) Applicants: TOYOTA JIDOSHA KABUSHIKI KAISHA, Toyota-shi (JP); TOHOKU UNIVERSITY, Sendai-shi (JP)

(72) Inventors: Shinji ICHIKAWA, Toyota-shi (JP); Hidetoshi MATSUKI, Sendai-shi (JP); Tetsuya TAKURA, Sendai-shi (JP); Fumihiro SATO, Sendai-shi (JP)

(21) Appl. No.: 14/466,322

(22) Filed: Aug. 22, 2014

(30) Foreign Application Priority Data
Aug. 29, 2013 (JP) 2013-178104

(51) Int. Cl. H01F 38/14; H02J 7/02; B60R 16/03; H02J 5/00

(52) U.S. Cl. CPC H01F 38/14; H02J 5/005; H02J 7/025; B60R 16/03
USPC 307/104

(57) ABSTRACT

A coil unit of a power reception device includes a coil through which electric power output from a power transmission device is received in a contactless manner; and a core around which the coil is wound, The core includes a plate-shaped first core, and a plate-shaped second core disposed so as to face the first core at a distance from the first core. The coil is wound around the first core and the second core so as to extend over the first core and the second core. Consequently, the power reception device and the power transmission device each can be reduced in physical size while an electrical device can be less influenced by an electromagnetic field generated during power transfer.

This nonprovisional application is based on Japanese Patent Application No. 2013-178104 filed on Aug. 29, 2013 with the Japan Patent Office, the entire contents of which are hereby incorporated by reference.

### BACKGROUND OF THE INVENTION

1. Field of the Invention

The present invention relates to a power reception device, a power transmission device and a power transfer system, and particularly to a power transfer system transferring electric power from a power transmission device to a power reception device in a contactless manner, and the power reception device and the power transmission device used therefor.

2. Description of the Background Art

Japanese Patent Laying-Open No. 2013-121258 discloses a contactless power transfer device transferring electric power in a contactless manner. This contactless power transfer device includes a power transmitter and a power receptor. Each of the power transmitter and the power receptor includes a plate-shaped ferrite core; a coil wound around the plate-shaped ferrite core in a spiral manner; and a capacitor (condenser) connected in parallel with the coil (see Japanese Patent Laying-Open No. 2013-121258).

The capacitor and other devices (for example, a cooler, a rectifier, a filter, and the like) electrically connected to the coil may be disposed near a coil unit formed of a core and a coil. When these devices are disposed around the coil unit, the power transmitter and the power receptor are increased in physical size. Furthermore, the electrical device disposed around the coil unit may be adversely influenced by the high-intensity electromagnetic field generated at the time of power transfer.

### SUMMARY OF THE INVENTION

Therefore, an object of the present invention is to provide a power reception device, a power transmission device and a power transfer system that are configured to transfer electric power in a contactless manner, for allowing reduction in a physical size of each of the power reception device and the power transmission device and also allowing suppression of the influence of the electromagnetic field generated during power transfer upon an electrical device.

According to the present invention, a power reception device includes a coil through which electric power output from a power transmission device is received in a contactless manner; and a core around which the coil is wound. The core includes a plate-shaped first core unit and a plate-shaped second core unit disposed so as to face the first core unit at a distance from the first core unit. The coil is wound around the first core unit and the second core unit so as to extend over the first core unit and the second core unit.

Preferably, the power reception device further includes a device disposed in a space between the first core unit and the second core unit.

Further preferably, the device is an electrical device electrically connected to the coil.

Preferably, the distance between the first core unit and the second core unit is equal to or greater than a total value of a thickness of the first core unit and a thickness of the second core unit.

Preferably, the power reception device further includes a housing in which the coil and the core are housed, and a plurality of devices provided within the housing.

All of the plurality of devices are disposed in a space between the first core unit and the second core unit.

Preferably, the first core unit and the second core unit are plate-shaped members formed separately from each other.

Further preferably, the core is formed in a square tubular shape. The first core unit and the second core unit are opposing walls of the core formed in the square tubular shape.

Furthermore, according to the present invention, a power transmission device includes a coil through which electric power is transmitted to a power reception device in a contactless manner; and a core around which the coil is wound. The core includes a plate-shaped first core unit and a plate-shaped second core unit disposed so as to face the first core unit at a distance from the first core unit. The coil is wound around the first core unit and the second core unit so as to extend over the first core unit and the second core unit.

Preferably, the power transmission device further includes a device disposed in a space between the first core unit and the second core unit.

Further preferably, the device is an electrical device electrically connected to the coil.

Preferably, the distance between the first core unit and the second core unit is equal to or greater than a total value of a thickness of the first core unit and a thickness of the second core unit.

Preferably, the power transmission device further includes a housing in which the coil and the core are housed; and a plurality of devices provided within the housing. All of the plurality of devices are disposed in a space between the first core unit and the second core unit.

Preferably, the first core unit and the second core unit are plate-shaped members formed separately from each other.

Further preferably, the core is formed in a square tubular shape. The first core unit and the second core unit are opposing walls of the core formed in the square tubular shape.

Furthermore, according to the present invention, a power transfer system includes a power transmission device and a power reception device. The power transmission device includes a first coil through which electric power is transmitted to the power reception device in a contactless manner, and a first core around which the first coil is wound. The power reception device includes a second coil through which electric power output from the power transmission device is received in a contactless manner, and a second core around which the second coil is wound. The first core and the second core each include a plate-shaped first core unit, and a plate-shaped second core unit disposed so as to face the first core unit at a distance from the first core unit. The first coil and the second coil each are wound around the first core unit and the second core unit so as to extend over the first core unit and the second core unit.

As described above, according to the present invention, a coil is wound around the plate-shaped first and second core units so as to extend over these first and second core units disposed so as to face each other at a distance from each other, thereby forming a low electromagnetic field region in the space between the first core unit and the second core unit. Thus, a capacitor and other devices can be housed in the space between the first core unit and the second core unit. Therefore, according to the present invention, the power transmission device and the power reception device can be reduced in physical size while the electrical device can be less influenced by the electromagnetic field generated at the time of power transfer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an entire configuration diagram of a power transfer system according to the first embodiment of the present invention.

FIG. 2 is a plan view of a vehicle showing a planar arrangement of a power reception unit.

FIG. 3 is a diagram of an electrical circuit implementing contactless power transfer in the power transfer system shown in FIG. 1.

FIG. 4 is a perspective view of a coil unit of the power reception unit.

FIG. 5 is a cross-sectional view taken along an arrow line V-V in FIG. 4.

FIG. 6 is a diagram for illustrating an electromagnetic field formed at the time of power transfer from a power transmission unit to the power reception unit.

FIG. 7 is a diagram showing a change in a coupling coefficient in the case where a gap between the first core and the second core is changed in the coil unit.

FIG. 8 is a plan view of the power reception unit in the first embodiment.

FIG. 9 is a cross-sectional view taken along an arrow line XI-XI in FIG. 8.

FIG. 10 is a plan view of a power reception unit in the second embodiment.

FIG. 11 is a cross-sectional view of a coil unit of a power reception unit in the third embodiment.

### DESCRIPTION OF THE PREFERRED EMBODIMENTS

The embodiments of the present invention will be hereinafter described in detail with reference to the accompanying drawings. In the following, although a plurality of embodiments will be described, it has been originally intended to combine the configurations described in each embodiment as appropriate in the present application. In the drawings, the same or corresponding components are designated by the same reference characters, and description thereof will not be repeated.

[First Embodiment]

(Configuration of Power Transfer System)

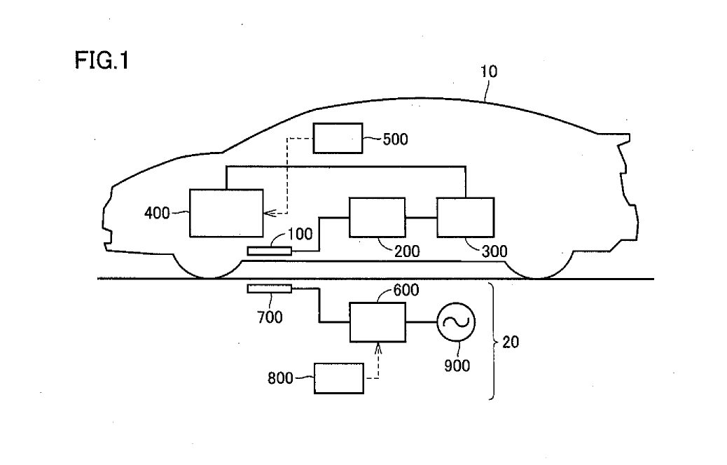

FIG. 1 is an entire configuration diagram of a power transfer system according to the first embodiment of the present invention. Referring to FIG. 1, this power transfer system includes a vehicle 10 and a power transmission device 20. Vehicle 10 includes a power reception unit 100, a rectifier circuit 200, a power storage device 300, a motive power generation device 400, and a vehicle ECU (Electronic Control Unit) 500.

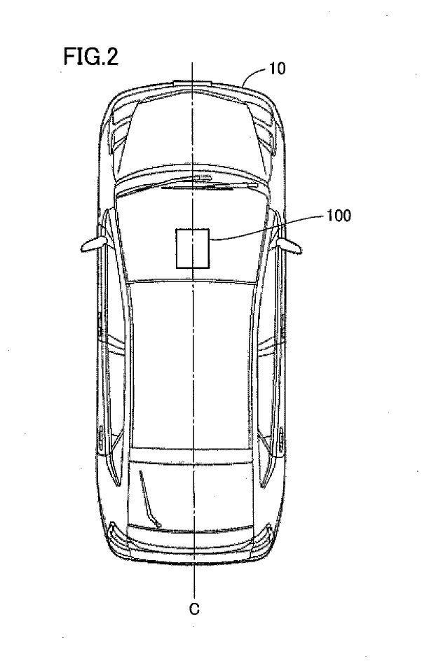

Power reception unit 100 includes a coil through which electric power (alternating current) output from a power transmission unit 700 (described later) of power transmission device 20 is received in a contactless manner. Power reception unit 100 outputs the received electric power to rectifier circuit 200. In this first embodiment, power transmission device 20 is provided on the surface of the ground or in the ground while power reception unit 100 is provided in the lower part of the vehicle body and closer to the forward part of the vehicle body. As shown in the plan view of the vehicle in FIG. 2, power reception unit 100 is provided approximately in the center of the vehicle body in the width direction thereof (a line C shows the center line of the vehicle body in FIG. 2).

It is to be noted that the position of power reception unit 100 to be placed is not limited to the above. For example, power reception unit 100 may be disposed in the lower part of the vehicle body and closer to the rearward part of the vehicle body. If power transmission device 20 is provided above the vehicle, power reception unit 100 may be provided in the upper part of the vehicle body. The detailed configuration of power reception unit 100 will be described later.

Again referring to FIG. 1, rectifier circuit 200 rectifies the AC (alternating-current) power received by power reception unit 100 and outputs the rectified power to power storage device 300. Although not shown in FIG. 1, a filter is provided between power reception unit 100 and rectifier circuit 200. It is to be noted that this filter is not an indispensable component, but may be provided as required.

Power storage device 300 is a rechargeable DC (direct-current) power supply and is configured of a secondary battery such as a lithium-ion battery or a nickel-metal hydride battery, for example. The voltage of power storage device 300 is, for example, approximately 200V. Power storage device 300 stores electric power output from rectifier circuit 200, and also stores the electric power generated by motive power generation device 400. Then, power storage device 300 supplies the stored electric power to motive power generation device 400. It is to be noted that a large capacity capacitor can also be employed as power storage device 300. Although not particularly shown, a DC-DC converter adjusting the output voltage of rectifier circuit 200 may be provided between rectifier circuit 200 and power storage device 300.

Motive power generation device 400 generates driving power for running of vehicle 10 using the electric power stored in power storage device 300. Although not particularly shown, motive power generation device 400, for example, includes an inverter receiving electric power from power storage device 300, a motor driven by the inverter, driving wheels driven by the motor, and the like. In addition, motive power generation device 400 may also include a power generator for charging power storage device 300 and an engine capable of driving the power generator.

Vehicle ECU 500 includes a CPU (Central Processing Unit), a storage device, an input/output buffer, and the like (each of which is not shown). This vehicle ECU 500 inputs the signals from various sensors and outputs the control signal to each device while controlling each device in vehicle 10. By way of example, vehicle ECU 500 performs running control of vehicle 10, and charging control of power storage device 300. It is to be noted that the above-described control is not limited to the process by software, but can be carried out by dedicated hardware (an electronic circuit).

Power transmission device 20 includes a power supply unit 600, a power transmission unit 700 and a power supply ECU 800. Power supply unit 600 receives electric power from an external power supply 900 such as a commercial system power supply, and generates AC power having a prescribed transmission frequency. Power supply unit 600 supplies the generated AC power to power transmission unit 700. By way of example, power supply unit 600 includes a rectification unit rectifying the electric power from external power supply 900, and a single-phase inverter generating AC power having a transmission frequency (each of which is not shown). It is to be noted that the rectification unit is not required when external power supply 900 is a DC power supply. The single-phase inverter is configured by a full-bridge circuit, for example.

Power transmission unit 700 includes a coil through which electric power is transmitted to power reception unit 100 of vehicle 10 in a contactless manner. Power transmission unit 700 receives the AC power having a transmission frequency from power supply unit 600, and transmits the received AC power to power reception unit 100 of vehicle 10 in a contactless manner through the electromagnetic field generated around power transmission unit 700. Although not shown in FIG. 1, a filter is provided between power supply unit 600 and power transmission unit 700. This filter is not an indispensable component, but may be provided as required.

Power supply ECU 800 includes a CPU, a storage device, an input/output buffer, and the like (each of which is not shown). This Power supply ECU 800 inputs the signals from various sensors and outputs the control signal to each device while controlling each device in power transmission device 20. By way of example, power supply ECU 800 carries out switching control of power supply unit 600 so as to cause power supply unit 600 (inverter) to generate AC power having a transmission frequency. It is to be noted that the above-described control is not limited to the process by software, but can be carried out by dedicated hardware (an electronic circuit).

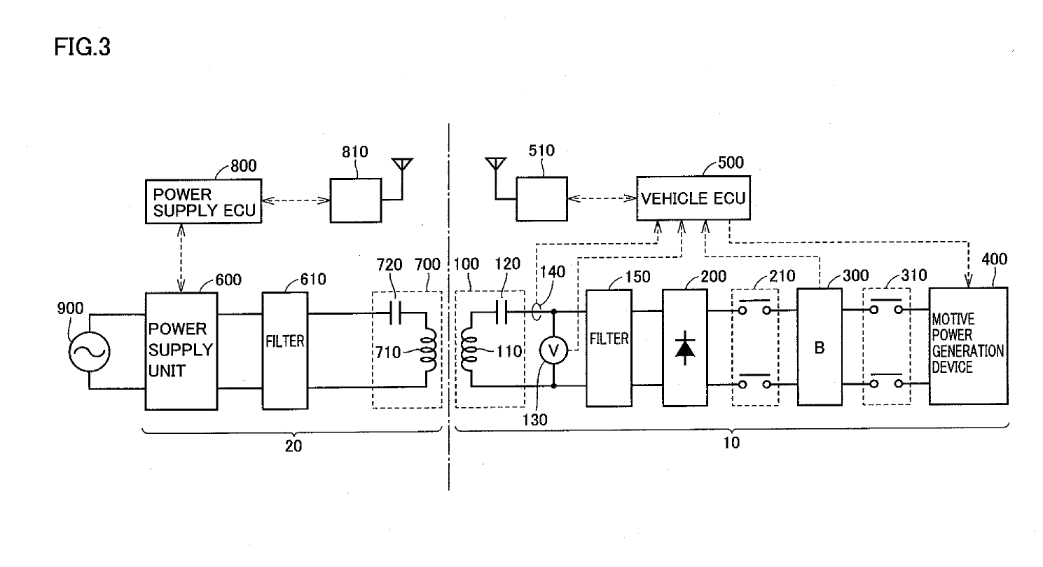

FIG. 3 is a diagram of an electrical circuit implementing contactless power transfer in the power transfer system shown in FIG. 1. It is to be noted that the circuit configuration shown in this FIG. 3 is merely by way of example, and the configuration for implementing contactless power transfer is not limited to the configuration in FIG. 3.

Referring to Fig, 3, power reception unit 100 of vehicle 10 includes a coil unit 110 and a capacitor 120. Coil unit 110 receives electric power from power transmission unit 700 of power transmission device 20 in a contactless manner, and outputs the received electric power to a filter 150. Capacitor 120 is connected in series to coil unit 110 to form an LC resonance circuit together with coil unit 110. Capacitor 120 is provided for adjusting the resonance frequency of power reception unit 100. Capacitor 120 may be connected in parallel with coil unit 110. It is to be noted that capacitor 120 does not have to be provided in the case where a desired resonance frequency can be obtained utilizing the stray capacitance of coil unit 110.

A voltage sensor 130 detects the voltage of power reception unit 100, and outputs the detected value to vehicle ECU 500. A current sensor 140 detects the current of power reception unit 100, and outputs the detected value to vehicle ECU 500.

Filter 150 is provided between power reception unit 100 and rectifier circuit 200. Filter 150 suppresses the harmonic noise generated from rectifier circuit 200 during reception of electric power from power transmission device 20. By way of example, filter 150 is formed of an LC filter including a capacitor connected in parallel with power reception unit 100 and a coil provided between one end of the connection node of the capacitor and rectifier circuit 200.

A relay 210 is provided between rectifier circuit 200 and power storage device 300. Relay 210 is turned on by vehicle ECU 500 while power storage device 300 is charged by power transmission device 20. A system main relay (SMR) 310 is provided between power storage device 300 and motive power generation device 400. SMR 310 is turned on by vehicle ECU 500 when startup of motive power generation device 400 is requested.

In addition, vehicle ECU 500 communicates with power transmission device 20 using a communication device 510 while power storage device 300 is charged by power transmission device 20, and exchanges information about start/stop of charging, power receiving conditions of vehicle 10 and the like with power transmission device 20.

In contrast, power transmission unit 700 of power transmission device 20 includes a coil unit 710 and a capacitor 720. Coil unit 710 transmits electric power supplied from power supply unit 600 to power reception unit 100 of vehicle 10 in a contactless manner. Capacitor 720 is connected in series to coil unit 710 to form an LC resonance circuit together with coil unit 710. Capacitor 720 is provided for adjusting the resonance frequency of power transmission unit 700. Capacitor 720 may be connected in parallel with coil unit 710. In addition, capacitor 720 does not have to be provided in the ease where a desired resonance frequency can be obtained utilizing the stray capacitance of coil unit 710.

A filter 610 is provided between power supply unit 600 and power transmission unit 700. Filter 610 suppresses the harmonic noise generated from power supply unit 600. By way of example, filter 610 is formed of an LC filter including a capacitor connected in parallel with power supply unit 600 and a coil provided between one end of the connection node of the capacitor and power supply unit 600.

In addition, at the time of power transmission to vehicle 10, power supply ECU 800 communicates with vehicle 10 using communication device 810, and exchanges information about start/stop of charging, power receiving conditions of vehicle 10 and the like with vehicle 10.

Although not particularly shown, power transmission device 20 is also provided with a voltage sensor and a current sensor for detecting transmitted electric power. These voltage sensor and current sensor may be provided between filter 610 and power transmission unit 700, or may be provided within power supply unit 600.

In power transmission device 20, AC power is supplied from power supply unit 600 through filter 610 to coil unit 710. This causes energy (electric power) to be transferred from coil unit 710 to coil unit 110 through the electromagnetic field formed between coil unit 710 and coil unit 110 of vehicle 10. The energy (electric power) transferred to coil unit 110 is supplied to power storage device 300 through filter 150 and rectifier circuit 200.

As described above, coil unit 710 forms an LC resonance circuit together with capacitor 720 in power transmission unit 700 of power transmission device 20. Also in power reception unit 100 of vehicle 10, coil unit 110 forms an LC resonance circuit together with capacitor 120. It is preferable that the difference between the resonance frequency of power transmission unit 700 and the natural frequency of power reception unit 100 is, for example, equal to or less than ±10% of the natural frequency of power transmission unit 700 or the natural frequency of power reception unit 100. Then, coil unit 710 receives electric power from power supply unit 600, and transmits the received electric power to power reception unit 100 of vehicle 10 in a contactless manner. Coil unit 110 of power reception unit 100 receives electric power from coil unit 710 of power transmission unit 700 in a contactless manner.

Although not particularly shown, in power transmission device 20, an isolation transformer may be provided between power transmission unit 700 and power supply unit 600 (for example, between power transmission unit 700 and filter 610). Furthermore, also in vehicle 10, an isolation transformer may be provided between power reception unit 100 and rectifier circuit 200 (for example, between power reception unit 100 and filter 150).

(Configuration of Coil Unit)

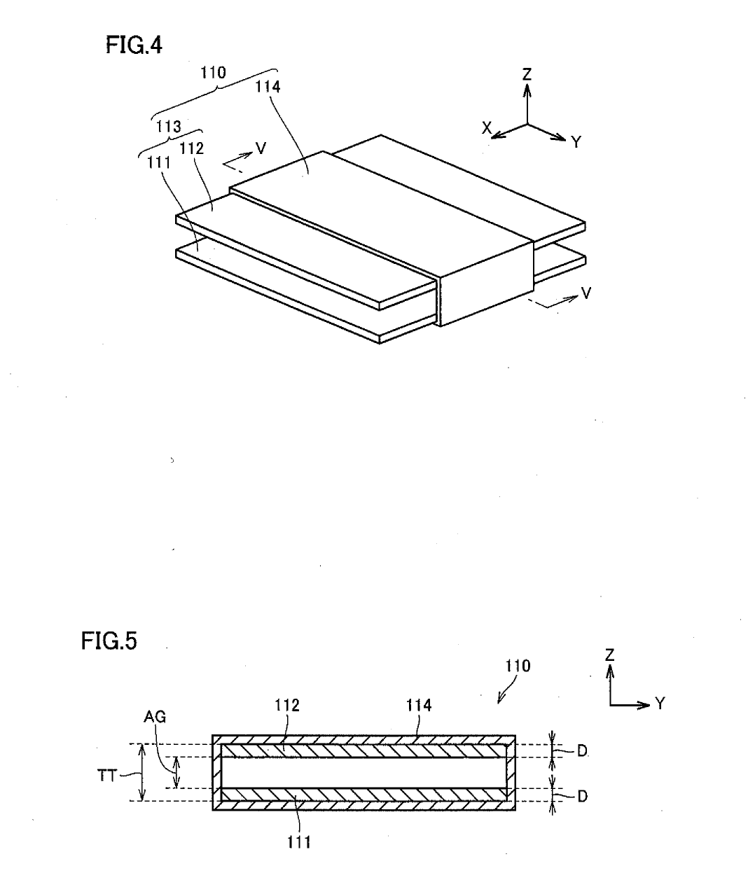

FIG. 4 is a perspective view of coil unit 110 of power reception unit 100. FIG. 5 is a cross-sectional view taken along an arrow line V-V in FIG. 4. Coil unit 710 of power transmission unit 700 is also similar in configuration to coil unit 110. In these FIGS. 4 and 5, the configuration of coil unit 110 will be representatively described. Since the description of the configuration of coil unit 710 is the same as that of coil unit 110 described below, the description thereof will not be repeated. In the figures, “X” indicates the direction in which the vehicle moves forward, “Y” indicates the leftward direction of the vehicle, and “Z” indicates the upward direction of the vehicle. In addition, “Y” may indicate the direction in which vehicle moves forward, and “X” may indicate the rightward direction of the vehicle.

Referring to FIGS. 4 and 5, coil unit 110 includes a core 113 and a coil. 114. Core 113 is formed of a first core 111 and a second core 112. First core 111 and second core 112 each are formed of a magnetic material, and representatively formed of ferrite, but may be formed of a magnetic material other than ferrite. Each of first core 111 and second core 112 is formed in a shape of a plate having a thickness D, for example, and has a rectangular shape as seen in a plan view along the Z-axis direction.

First core 111 is disposed so as to extend along the X-Y plane. Second core 112 is provided above first core 111 in the vehicle body (in the Z-axis positive direction) and disposed so as to face first core 111 while leaving a gap AG from first core 111.

Coil 114 is electrically connected to capacitor 120 and filter 150 (not shown). Coil 114 is spirally wound around first core 111 and second core 112 about the X-axis direction as an axis around which coil 114 is wound, such that coil 114 extends over first core 111 and second core 112. In other words, coil 114 does not exist in the space between first core 111 and second core 112, but is wound so as to extend over first core 111 and second core 112 at the end faces of these first core 111 and second core 112 in the Y-axis direction,

In addition, while FIG. 4 does not describe each winding of coil 114 in detail, coil 114 is specifically formed in a spiral shape so as to surround first core 111 and second core 112 and extend in the X-axis direction, as coil 114 is wound from one end to the other end. Furthermore, although not shown, coil unit 110 is housed in the housing (case).

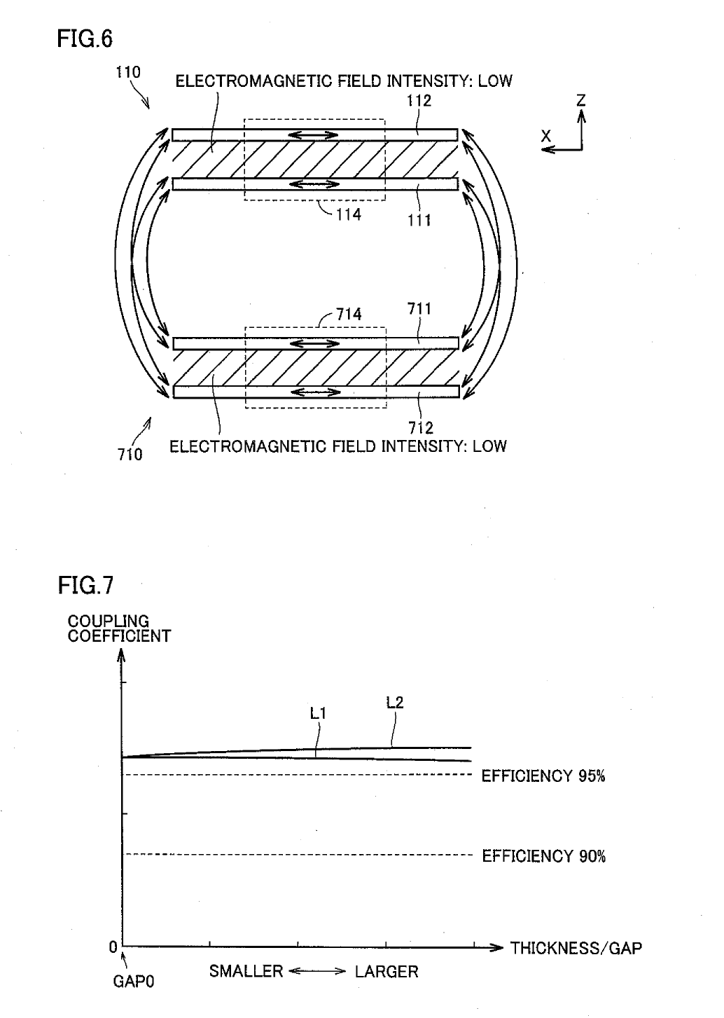

FIG. 6 is a diagram for illustrating an electromagnetic field formed at the time of power transfer from power transmission unit 700 to power reception unit 100. Referring to FIG. 6, coil unit 710 of power transmission unit 700 includes a first core 711, a second core 712 and a coil 714.

When a current is supplied to coil 714 of coil unit 710, an electromagnetic field of high intensity is formed inside first core 711 and second core 712 each formed of a magnetic material. Accordingly, an electromagnetic field oscillating with a transmission frequency is formed between coil unit 110 of power reception unit 100 and each of first core 711 and second core 712, thereby forming an electromagnetic field of high intensity inside first core 111 and second core 112 each formed of a magnetic material. This induces a current in coil 114 and electric power is extracted from coil 114.

In this way, in coil unit 110, an electromagnetic field of high intensity is formed inside first core 111 and second core 112 while the intensity of the electromagnetic field in the space between first core 111 and second core 112 is relatively low. Similarly, in coil unit 710, an electromagnetic field of high intensity is formed inside first core 711 and second core 712, while the intensity of the electromagnetic field in the space between first core 711 and second core 712 is relatively low. Thus, according to this first embodiment, a device such as a capacitor is disposed in a region of power reception unit 100 that is formed between first core 111 and second core 112 of coil unit 110, and also in a region of power transmission unit 700 that is formed between first core 711 and second core 712 of coil unit 710, as described later. Consequently, the space between the first core and the second core is used as a place in which a device such as a capacitor is arranged, so that each of power reception unit 100 and power transmission unit 700 can be reduced in physical size while the electrical device can be less influenced by the electromagnetic field generated during power transfer from power transmission unit 700 to power reception unit 100.

FIG. 7 is a diagram showing a change in a coupling coefficient κ in the case where a gap AG between the first core and the second core is changed in the coil unit. In this case, the size of gap AG is set to be the same in power transmission unit 700 and power reception unit 100 (changed by the same amount). Furthermore, as a comparative example, the figure also shows a change in coupling coefficient x at the time when a thickness TT is changed in the case where the core is formed of one core having thickness TT (FIG. 5).

Referring to FIG. 7, the horizontal axis shows the sum of gap AG, the thickness of the first core and the thickness of the second core (in the comparative example, the horizontal axis shows thickness TT of the core). The vertical axis shows coupling coefficient K. A line Li shows a change in coupling coefficient κ in this first embodiment while a line L2 shows a change in coupling coefficient κ in the comparative example. It is to be noted that “efficiency 90%” shows a line obtained when the efficiency of power transfer from the power transmission unit to the power reception unit is 90% while “efficiency 95%” shows a line obtained when the efficiency of power transfer from the power transmission unit to the power reception unit is 95%.

As shown in the figure, even if the core is formed of the first core and the second core each formed in a shape of a plate, and gap AG is provided between the first core and the second core, a significant decrease in each of the coupling coefficient and the power transfer efficiency is not observed, as compared with the case of the conventional-type core shown in the comparative example. By way of example, even if gap AG is set to be equal to or greater than a total value of the thickness of the first core and the thickness of the second core, a significant decrease in each of the coupling coefficient and the power transfer efficiency is not observed. Even if gap AG is increased at least to approximately 4 times as the total value of the thickness of the first core and the thickness of the second core, a significant decrease in each of the coupling coefficient and the power transfer efficiency is not observed.

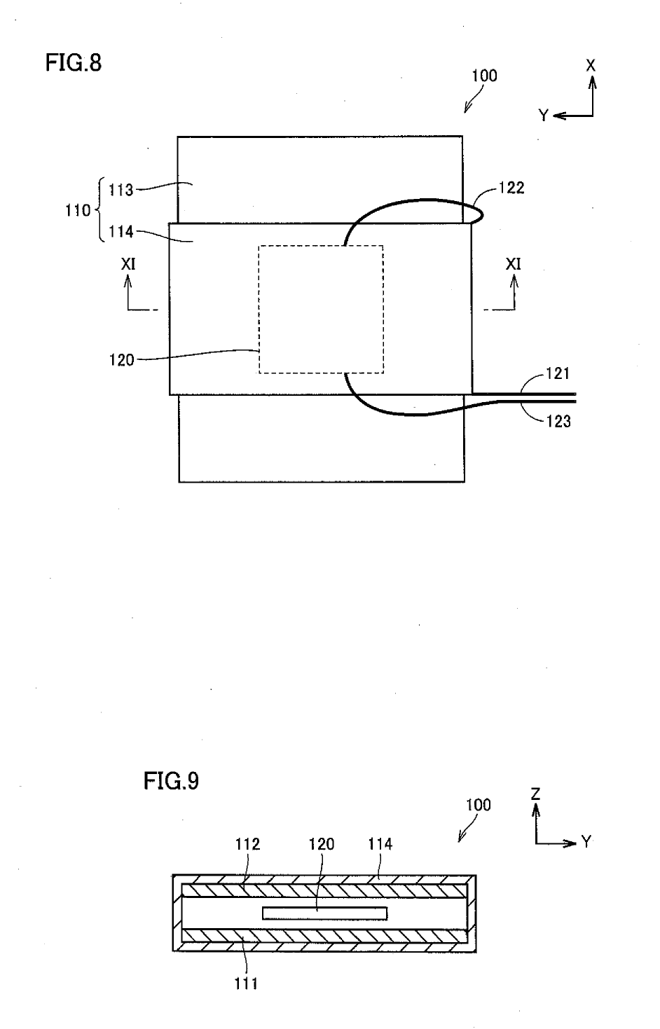

FIG. 8 is a plan view of power reception unit 100 in this first embodiment. FIG. 9 is a cross-sectional view taken along an arrow line XI-XI in FIG. 8. Power transmission unit 700 is also similar in configuration to power reception unit 100. Also in these FIGS. 8 and 9, the configuration of power reception unit 100 will be representatively described. Since the description of the configuration of power transmission unit 700 is the same as that of power reception unit 100 described below, the description thereof will not be repeated.

Referring to FIGS. 8 and 9, capacitor 120 is disposed in a region formed between first core 111 and second core 112. As described above, since the electromagnetic field intensity of the space between first core 111 and second core 112 is relatively low, capacitor 120 is to be disposed in this region. Consequently, power reception unit 100 is reduced in physical size while capacitor 120 is less influenced by the electromagnetic field generated during power transfer from power transmission unit 700 to power reception unit 100.

In addition, a power line 121 has one end connected to one end of coil 114 and the other end (not shown) connected to filter 150 (FIG. 3). A power line 122 has one end connected to the other end of coil 114 and the other end connected to one end of capacitor 120. A power line 123 has one end connected to the other end of capacitor 120 and the other end (not shown) connected to filter 150. Power lines 121 and 123 are extended from power reception unit 100 while being located in proximity to each other. This allows easy wiring between power reception unit 100 and filter 150.

It is preferable that capacitor 120 is formed relatively thin in consideration of the fact that it is disposed in a region formed between first core 111 and second core 112. By way of example, capacitor 120 is formed of a substrate, a wiring circuit formed on the surface of the substrate, and a plurality of ceramic condensers provided on the wiring circuit. By such a configuration, capacitor 120 can also be formed thin so as to have a thickness of about several millimeters, and therefore, can be disposed in a region formed between first core 111 and second core 112. Furthermore, when a strong electromagnetic field is applied to the capacitor having such a configuration, the wiring circuit may be raised in temperature. In this first embodiment, however, since capacitor 120 is disposed in a region of a low electromagnetic field formed between first core 111 and second core 112, there occurs no such a problem that the wiring circuit is raised in temperature. In addition, when a relatively larger gap AG is provided between first core 111 and second core 112, capacitor 120 is not necessarily limited to the configuration as described above.

Although power transmission unit 700 is not particularly shown, capacitor 720 (FIG. 3) is disposed in a region formed between first core 711 and second core 712. Consequently, power transmission unit 700 is reduced in physical size while capacitor 720 is less influenced by the electromagnetic field generated during power transfer from power transmission unit 700 to power reception unit 100.

As described above, according to this first embodiment, in power reception unit 100 of vehicle 10, coil 114 is wound around plate-shaped first core 111 and second core 112 so as to extend over these first core 111 and second core 112 disposed to face each other at a distance from each other, thereby forming a region of a low electromagnetic field in the space between first core 111 and second core 112. Then, capacitor 120 is housed in the space between first core 111 and second core 112. Therefore, according to this first embodiment, power reception unit 100 can be reduced in physical size while capacitor 120 can be less influenced by the electromagnetic field generated during power transfer.

Furthermore, according to this first embodiment, also in power transmission unit 700 of power transmission device 20, coil 714 is wound around plate-shaped first core 711 and second core 712 so as to extend over these first core 712 and second core 712 disposed to face each other at a distance from each other, thereby forming a region of a low electromagnetic field in the space between first core 711 and second core 712. Then, capacitor 720 is housed in the space between first core 711 and second core 712. Therefore, according to this first embodiment, power transmission unit 700 can be reduced in physical size while capacitor 720 can be less influenced by the electromagnetic field generated during power transfer.

[Second Embodiment]

In the second embodiment, not only a capacitor but also other devices are housed within a case in which the coil unit is housed. Then, devices other than the capacitor are also arranged together with the capacitor in the region formed between the first core and the second core.

The entire configuration and the electrical circuit configuration of the power transfer system in the second embodiment are the same as those in the above-described first embodiment.

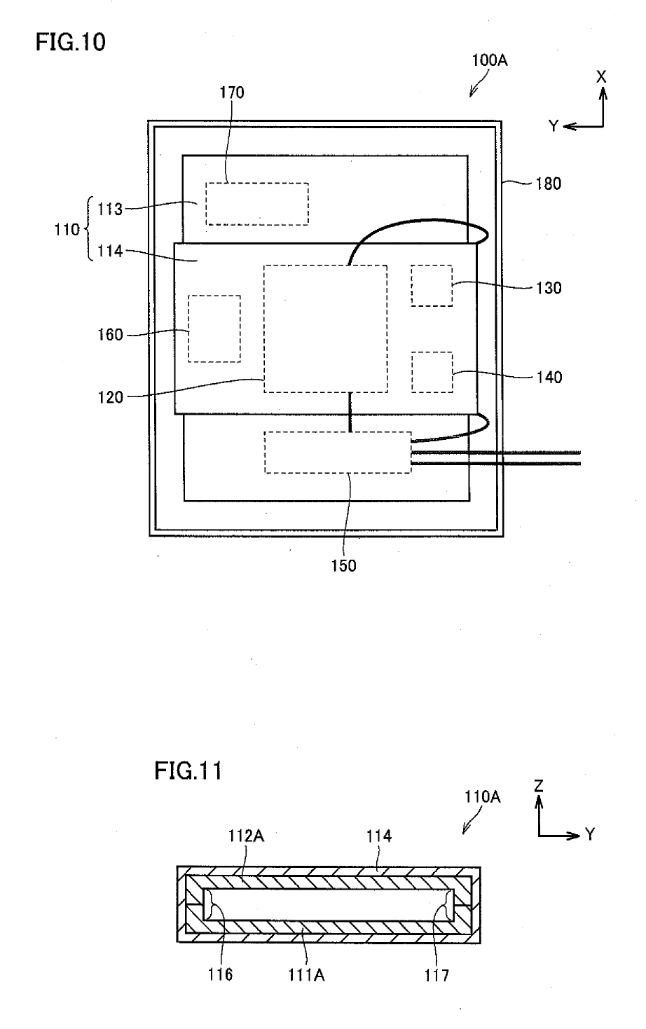

FIG. 10 is a plan view of a power reception unit in the second embodiment. The power transmission unit of power transmission device 20 is also similar in configuration to the power reception unit. In this FIG. 10, the configuration of the power reception unit will be representatively described. Since the detailed description of the configuration of the power transmission unit is the same as that of the power reception unit described below, the description thereof will not be repeated.

Referring to FIG. 10, in a power reception unit 100A in the second embodiment, coil unit 110 is housed in a case (housing) 180. In addition to capacitor 120, case 180 further houses a voltage sensor 130, a current sensor 140, a filter 150, a cooling device 160, and other devices 170. All of the devices housed in case 180 are arranged between first core 111 and second core 112 that form core 113. In this way, each of the devices housed in case 180 is arranged in the region between first core 111 and second core 112, so that power reception unit 100A can be reduced in physical size. Furthermore, since coil unit 110 can be arranged bilaterally symmetrically in the X-axis direction within case 180, power reception unit 100A and the power transmission unit of power transmission device 20 can be readily aligned with each other at the time of parking.

It is to be noted that various devices that may be housed in case 180 are collectively indicated as devices 170. For example, devices 170 may include rectifier circuit 200 (FIG. 3). Alternatively, devices 170 may also include relay 210, a fuse, a cooling duct, and the like. Furthermore, although capacitor 120 and rectifier circuit 200 are electrically connected to coil 114, the devices arranged between first core 111 and second core 112 are not limited to those electrically connected to coil 114, but may also include voltage sensor 130, current sensor 140, cooling device 160, and the like.

It is to be noted that the devices housed in case 180 and arranged between first core 111 and second core 112 are not limited to those described above, but may be a part of the above-described devices, or may also include still other devices. Furthermore, although it is preferable that all of the devices housed in case 180 are arranged between first core 111 and second core 112, all of the devices housed in case 180 are not necessarily arranged between first core 111 and second core 112.

Although not particularly shown, also in the power transmission unit of power transmission device 20, coil unit 710 is housed in the case, and all of the devices housed in the case are arranged between first core 711 and second core 712. In addition to capacitor 720, for example, such devices may include filter 610 (FIG. 3), a voltage sensor, a current sensor, a cooling device, a cooling duct, a relay, a fuse, and the like. Although it is preferable that all of the devices housed in the case are arranged between first core 711 and second core 712, all of the devices housed in the case are not necessarily arranged between first core 711 and second core 712.

As described above, according to this second embodiment, since various devices housed in the case are housed in the space between the first core and the second core, the power reception unit and the power transmission unit each can be reduced in physical size. Furthermore, all of the devices housed in the case are housed in the space between the first core and the second core, thereby eliminating the need to ensure the space around the coil unit for allowing each device to be arranged therein. Accordingly, the coil unit can be arranged bilaterally symmetrically in the X-axis direction. Therefore, according to this second embodiment, alignment between the power transmission unit and the power reception unit (alignment of vehicle 10 with power transmission device 20) can be readily achieved.

[Third Embodiment]

In the first and second embodiments, the core of the coil unit is formed of the plate-shaped first and second cores disposed so as to face each other at a distance from each other. In contrast, in this third embodiment, the core of the coil unit is formed of a core in a square tubular shape.

The entire configuration and the electrical circuit configuration of the power transfer system in this third embodiment are the same as those in the above-described first and second embodiments.

FIG. 11 is a cross-sectional view of a coil unit of a power reception unit in the third embodiment. This cross-sectional view corresponds to the cross-sectional view shown in FIG. 5. In addition, the coil unit of the power transmission unit is also similar in configuration to the coil unit of the power reception unit, In this FIG. 11, the configuration of the coil unit of the power reception unit will be representatively described. Since the detailed description of the configuration of the coil unit in the power transmission unit is the same as that of the coil unit in the power reception unit described below, the description thereof will not be repeated.

Referring to FIG. 11, a coil unit 110A includes a first core 111A, a second core 112A and a coil 114. First core 111A has edge portions at its both ends in the Y-axis direction that extend in the Z-axis positive direction in the configuration of the plate-shaped first core 111 shown in FIG. 5. Second core 112A has edge portions at its both ends in the Y-axis direction that extend in the Z-axis negative direction in the configuration of the plate-shaped second core 112 shown in FIG. 5. Thus, the above-described edge portions of first core 111 A and the above-described edge portions of second core 112A form sidewalls 116 and 117. In other words, first core 111A and second core 112A form a core in a square tubular shape having an inner space.

Also according to such a configuration, the intensity of the electromagnetic field is relatively lower in the region between the plate-shaped portion of first core 111A and the plate-shaped portion of second core 112A, that is, the region surrounded by first core 111A and second core 112A, as in the first and second embodiments.

Thus, in this third embodiment, capacitor 120 and other devices are housed (not shown) in the inner space of the square-tubular core formed by first core 111A and second core 112A. The devices housed within the square-tubular core are the same as those in the first and second embodiments.

Although the core in a square tubular shape is formed by first core 111A and second core 112A in the above description, the core in a square tubular shape may be integrally formed without using separate first core 111A and second core 112A. In addition, the core in a square tubular shape is formed by separate first core 111A and second core 112A, so that the core can be readily manufactured while the installability can be improved at the time when the devices are housed within the core in a square tubular shape.

Although not particularly shown, the coil unit in the power transmission unit of power transmission device 20 may also be formed by a core in a square tubular shape, as with coil unit 110A described above. Also, capacitor 720 and other devices may be housed in the inner space of the square-tubular core.

According to this third embodiment, the core is formed in a square tubular shape, thereby allowing improvement in the strength of the core while achieving the effect similar to those in the first and second embodiments.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A power reception device comprising:
a coil through which electric power output from a power transmission device is received in a contactless manner; and
a core around which said coil is wound,
said core including
a plate-shaped first core unit, and
a plate-shaped second core unit disposed so as to face said first core unit at a distance from said first core unit,
said coil being wound around said first core unit and said second core unit so as to extend over said first core unit and said second core unit.

2. The power reception device according to claim 1, further comprising a device disposed in a space between said first core unit and said second core unit.

3. The power reception device according to claim 2, wherein said device is an electrical device electrically connected to said coil.

4. The power reception device according to claim 1, wherein the distance between said first core unit and said second core unit is equal to or greater than a total value of a thickness of said first core unit and a thickness of said second core unit.

5. The power reception device according to claim 1, further comprising:
a housing in which said coil and said core are housed; and
a plurality of devices provided within said housing,
all of said plurality of devices being disposed in a space between said first core unit and said second core unit.

6. The power reception device according to claim 1, wherein said first core unit and said second core unit are plate-shaped members formed separately from each other.

7. The power reception device according to claim 1, wherein
said core is formed in a square tubular shape, and
said first core unit and said second core unit are opposing walls of said core formed in the square tubular shape.

8. A power transmission device comprising:
a coil through which electric power is transmitted to a power reception device in a contactless manner; and
a core around which said coil is wound,
said core including
a plate-shaped first core unit, and
a plate-shaped second core unit disposed so as to face said first core unit at a distance from said first core unit,
said coil being wound around said first core unit and said second core unit so as to extend over said first core unit and said second core unit.

9. The power transmission device according to claim 8, further comprising a device disposed in a space between said first core unit and said second core unit.

10. The power transmission device according to claim 9, wherein said device is an electrical device electrically connected to said coil.

11. The power transmission device according to claim 8, wherein the distance between said first core unit and said second core unit is equal to or greater than a total value of a thickness of said first core unit and a thickness of said second core unit.

12. The power transmission device according to claim 8, further comprising:
a housing in which said coil and said core are housed; and
a plurality of devices provided within said housing,
all of said plurality of devices being disposed in a space between said first core unit and said second core unit.

13. The power transmission device according to claim 8, wherein said first core unit and said second core unit are plate-shaped members formed separately from each other.

14. The power transmission device according to claim 8, wherein
said core is formed in a square tubular shape, and
said first core unit and said second core unit are opposing walls of said core formed in the square tubular shape.

15. A power transfer system comprising:
a power transmission device; and
a power reception device,
said power transmission device including
a first coil through which electric power is transmitted to said power reception device in a contactless manner, and
a first core around which said first coil is wound,
said power reception device including
a second coil through which electric power output from said power transmission device is received in a contactless manner, and
a second core around which said second coil is wound,
said first core and said second core each including
a plate-shaped first core unit, and
a plate-shaped second core unit disposed so as to face said first core unit at a distance from said first core unit,
said first coil and said second coil each being wound around said first core unit and said second core unit so as to extend over said first core unit and said second core unit.
